(19) United States
(12) Patent Application Publication
(10) Pub. No.: US 2009/0301289 A1
(43) Pub. Date: Dec. 10, 2009

(54) Modular MIDI controller

(76) Inventor: Deshko Gynes, Los Angeles, CA (US)

Correspondence Address: Benman, Brown & Williams, Suite 2740, 2049 Century Park East, Los Angeles, CA, 90067, US

(21) Appl. No.: 12/157,563

(22) Filed: Jun. 10, 2008

(51) Int. Cl. G10H 7/00

(52) U.S. Cl. 84/645

(57) ABSTRACT

A modular MIDI controller. The novel controller includes two or more modules, each module including a plurality of controls, and a mechanism for connecting the modules together to form one unit. In an illustrative embodiment, each control is adapted to convert a mechanical action by a user into an electrical signal, and each module includes a processor adapted to convert the electrical signals from the controls into control messages. A system control unit receives the control messages from each module and generates a corresponding MIDI output. In a preferred embodiment, the controller includes a plurality of chassis connected together to form a controller having a desired size and shape. Each chassis is adapted to hold one or more modules and may include a slot for holding one or more removable modules.

### BACKGROUND OF THE INVENTION

1. Field of the Invention

The present invention relates to electronics. More specifically, the present invention relates to MIDI (Musical Instrument Digital Interface) controllers.

2. Description of the Related Art

MIDI (Musical Instrument Digital Interface) is a protocol that enables electronic musical instruments to interact with each other or with a computer or other electronic equipment. The MIDI data format is comprised of a series of event messages, such as “note on” and “note off” messages for indicating when a musical note should be played and at what pitch and intensity, and “control change” messages for controlling effects such as modulation, pan, sustain, reverb, etc. The MIDI signal is therefore not an audio signal, but digital message data that can be converted to an audio signal by a synthesizer or other sound generator. MIDI messages can also be used to control other types of MIDI compatible electronics such as lighting and visual effects.

A MIDI system typically includes a MIDI controller and a sound generator. A MIDI controller, which typically includes a musical keyboard or other tactile controls for interacting with a user, generates MIDI messages from user inputs and transmits the MIDI data to the sound generator. The sound generator, which may be a computer running synthesizing software or a stand-alone synthesizer, converts the MIDI data to an audio signal that can be played through a loudspeaker.

There are several different types of MIDI controllers, each designed for a particular application or type of user. For example, controllers for controlling note on/off messages (including pitch/timbre and/or intensity parameters) are typically designed to emulate conventional musical instruments and include musical keyboards (similar to a piano) and drum pads. Controllers typically used for controlling effects include sliders, knobs, faders, buttons, switches, pitch bend wheels, modulation wheels, etc.

Conventional MIDI controllers typically include several individual controls and are available in a variety of different sizes, types, and configurations. A user can typically find a controller that is well suited for one particular application; however, it may be difficult or impossible to find a product that is suitable for several different types of applications. For example, a user may use a controller with a full-sized keyboard when composing a song or recording parts for melodic instruments, switch to a controller with several drum pads for playing a rhythm section, and then switch to a controller with several sliders and knobs when mixing and adding audio effects to a composition. The user may also want a smaller portable controller with a smaller keyboard and a few sliders and knobs for controlling audio and visual effects while performing at a live show. With currently available MIDI devices, the user needs to buy a different product for each application. This can become prohibitively expensive and the multiple controllers can occupy a large amount of space, which is typically very limited in a studio environment. Currently, there is no single MIDI controller that can be reconfigured to meet the requirements of different applications.

Hence, a need exists in the art for a MIDI controller that can be reconfigured for various applications.

### SUMMARY OF THE INVENTION

The need in the art is addressed by the modular MIDI controller of the present invention. The novel controller includes two or more modules, each module including a plurality of controls, and a mechanism for connecting the modules together to form one unit. In an illustrative embodiment, each control is adapted to convert a mechanical action by a user into an electrical signal, and each module includes a processor adapted to convert the electrical signals from the controls into control messages. A system control unit receives the control messages from each module and generates a corresponding MIDI output. In a preferred embodiment, the controller includes a plurality of chassis connected together to form a controller having a desired size and shape. Each chassis is adapted to hold one or more modules and may include a slot for holding one or more removable modules. The multiple connecting chassis allow the user to adjust the size and shape of the controller, while the removable modules allow the user to easily reconfigure the type and number of controls in the controller.

### BRIEF DESCRIPTION OF THE DRAWINGS

FIG. 1a is a simplified diagram of a modular MIDI controller designed in accordance with an illustrative embodiment of the present teachings.

FIG. 1b is a simplified diagram showing a disassembled modular MIDI controller designed in accordance with an illustrative embodiment of the present teachings.

FIG. 2 is a simplified diagram of three chassis designed in accordance with an illustrative embodiment of the present teachings.

FIG. 3a is a simplified diagram showing an illustrative controller configuration for a modular controller designed in accordance with an illustrative embodiment of the present teachings.

FIG. 3b is a simplified diagram showing an illustrative controller configuration for a modular controller designed in accordance with an illustrative embodiment of the present teachings.

FIG. 3c is a simplified diagram showing an illustrative controller configuration for a modular controller designed in accordance with an illustrative embodiment of the present teachings.

FIG. 4 is a simplified electrical block diagram of a MDI controller designed in accordance with an illustrative embodiment of the present teachings.

FIG. 5 is a simplified flow diagram for an illustrative processing software for a central control unit designed in accordance with an illustrative embodiment of the present teachings.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

The present invention provides a novel MDI controller having a unique modular design that allows a user to reconfigure the controller as desired, changing the types and numbers of controls in the controller as well as its overall size and shape.

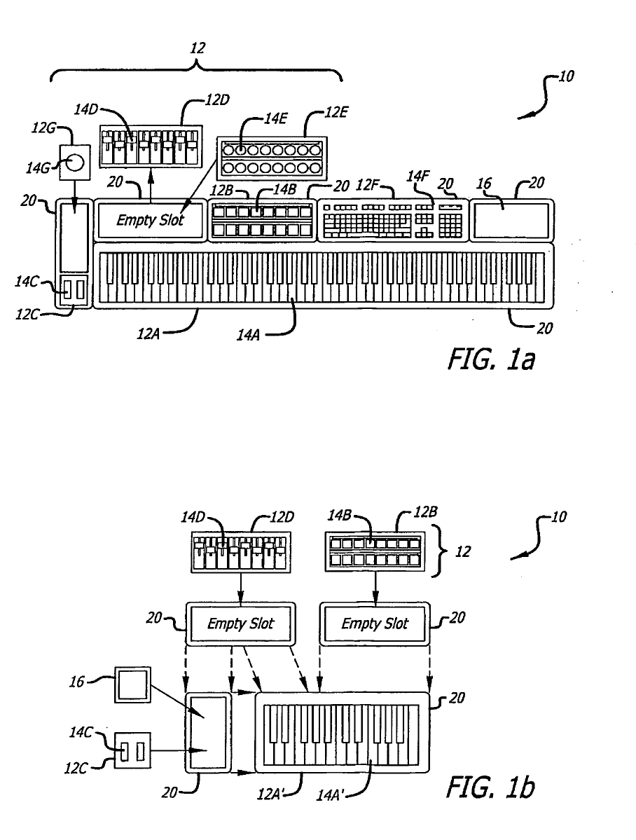

FIG. 1a is a simplified diagram of a modular MIDI controller 10 designed in accordance with an illustrative embodiment of the present teachings, showing one illustrative configuration. FIG. 1b is a simplified diagram of a disassembled modular MIDI controller 10 designed in accordance with an illustrative embodiment of the present teachings, showing a second illustrative configuration.

The novel MIDI controller 10 includes a plurality of control modules 12 that are connected together to form one unit 10. Each module 12 includes a plurality of individual tactile controls 14 for interfacing with a user. The individual controls 14 may include, for example, keys (on a musical keyboard or QWERTY keyboard), pads, buttons, sliders, knobs, wheels, ribbons, trackballs, touchscreens, etc. Each control 14 converts a mechanical action by the user (such as depressing a key or turning a knob) into an electrical signal, which is then converted to digital control data. In an illustrative embodiment, each module 12 includes a processor that converts the electrical signals from the controls 14 to encoded controller data, which includes digital messages that indicate when a particular control 14 is activated or deactivated and any parameters associated with the control 14 such as how hard a key is depressed or how much a knob is turned. Thus, the output of each module 12 is the digital message data, not the raw electrical signals from the controls 14.

In a preferred embodiment, several different types of modules 12 with different types of controls 14 are available for the controller 10. For example, in FIG. 1a, the controller 10 includes a module 12A having a full-sized musical keyboard with eighty-eight keys 14A, which are typically used to control note on/off messages and their parameters such as pitch (indicated by which key is depressed) and intensity (the amount of pressure on a key, typically corresponding with volume) or aftertouch messages (pressure changes after a note is on, typically for adding effects such as vibrato). In FIG. 1b, the controller 10 includes a module 12A′ having a smaller two octave keyboard with twenty-five keys 14A′.

Both configurations shown in FIGS. 1a and 1b include a module 12B having a plurality of drum pads 14B, which are also used to control note on/off messages with each drum pad typically corresponding to a different percussive instrument (timbre), and a module 12C having pitch bend and/or modulation wheels 14C, which are typically used for changing the pitch of a note or notes.

The controller 10 may also include a module 12D that includes a plurality of sliders 14D (shown in FIGS. 1a and 1b) and/or a module 12E that includes a plurality of knobs 14E (shown in FIG. 1a), both of which are typically used for controlling audio (or visual) effects in real time.

FIG. 1a also shows a module 12F having a QWERTY keyboard 14F, which may be used to generate MIDI control messages or to input data to a computer connected to the controller 10 or to one of the other modules 12. For example, in the embodiment of FIG. 1a, the drum pad module 12B includes small LCD displays above or below each drum pad 14B for displaying text (such as the name of the instrument corresponding to each pad 14B) that can be input by the user via the QWERTY keyboard 14F. Similarly, a module 12G having a track ball 14G can be used to generate MIDI control messages or to control a computer coupled to the controller 10.

Other types of modules 12 and controls 14, known now or invented in the future, can also be used without departing from the scope of the present teachings. Modules 12 may also include a combination of different types of controls 14.

The novel MIDI controller 10 also includes a system control module or “brain” 16 for controlling the overall operation of the controller 10. The system control module 16 includes a processor adapted to receive the data from each module 12 and combine and process the data to generate a single system output. In an illustrative embodiment, the system control module 16 encodes the data using a MIDI protocol. Thus, a single MIDI signal is output from the MIDI controller 10. The data may also be encoded using a protocol other than MIDI, including protocols known now or invented in the future, without departing from the scope of the present teachings.

In a preferred embodiment, the system control module 16 also includes a user interface such as a touchscreen for communicating with the user, allowing the user to, for example, set system parameters or provide input data for a control module 12 or a computer connected to the controller 10. The system module 16 may also be configured to provide additional MIDI control data by, for example, using virtual controls displayed on the touchscreen. Thus, the system control module 16 can function independently as a small controller (without the other modules 12).

In a preferred embodiment, in addition to providing the controller output signal (comprised of the combined data from the multiple control modules 12 and encoded using MIDI or some other protocol), the system module 16 can also be configured to remotely control a computer or synthesizer connected to the controller 10 by using the touchscreen and/or one or more control modules 12 (such as a QWERTY keyboard module 12F or trackball module 12G) to interface with the computer.

In accordance with the present teachings, the novel MIDI controller 10 also includes a mechanism for securely attaching the modules 12 together to form a single controller 10, which can be easily carried and moved around as one unit. In an illustrative embodiment, the controller 10 includes a plurality of chassis 20 for holding the modules 12 and connecting the modules 12 together.

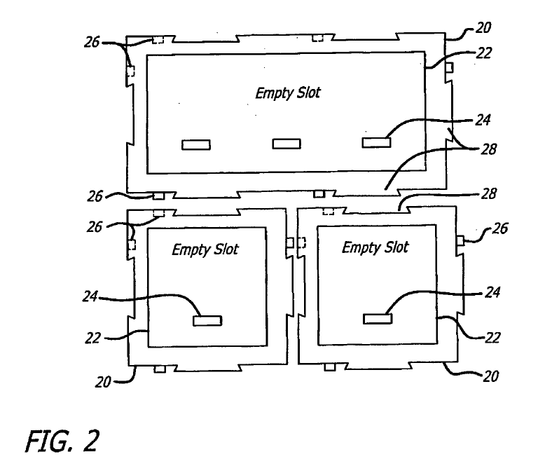

FIG. 2 is a simplified diagram of three chassis 20 designed in accordance with an illustrative embodiment of the present teachings, showing how the chassis 20 may be connected together to form a frame for the controller 10. Each chassis 20 includes a slot 22 adapted to hold one or more modules 12. Each slot 22 includes one or more electrical connectors 24 into which the module or modules 12 are plugged.

In an illustrative embodiment, each chassis 20 also includes one or more electrical connectors 26 on the outside of the chassis 20 for communicating data between modules 12 in adjacent chassis 20, or for communicating data between a system control module 16 and a computer or synthesizer. Internal wiring in the chassis 20 couples electrical signals between the slot connectors 24 (which are connected to the modules 12 or 16) and the chassis connectors 26 (which are connected to adjacent chassis 20). The electrical connectors 24 and 26 may also be adapted to supply power to the modules 12. In a preferred embodiment, the chassis connectors 26 can be connected to either a mating connector 26 in an adjacent chassis 20 or to a computer or synthesizer via a cable (with, for example, a USB or FireWire connector). Alternatively, a different type of chassis 20 may be provided for holding system modules 16 that includes connectors 26 for connecting with other chassis 20 as well as additional input/output connectors (such as USB, FireWire, Ethernet and/or MIDI connectors) for connecting to a computer or synthesizer.

Optionally, the control modules 12 and system modules 16 may also be equipped with integrated wireless technology (such as Bluetooth or Wi-Fi) for allowing the control modules 12 to communicate directly with the system control module 16, or for the system module 16 to communicate with a computer or synthesizer.

Modules 12 having unique sizes or shapes, such as keyboards or full-sized drum pads, may include chassis 20 that are integrated with the modules 12 instead of providing chassis 20 with slots 22 and removable modules 12. For example, as shown in FIG. 1b, the keyboard module 12A′ is integrated with its chassis 20.

As shown in FIG. 2, each chassis 20 includes physical features 28 for securely attaching the chassis 20 to adjacent chassis 20. In the illustrative embodiment, each side of the chassis 20 includes features 28 adapted to slide into complementary features 28 in an adjacent chassis 20 and lock the chassis 20 in place.

In a preferred embodiment, several different sized chassis 20 are available for forming the controller 10. The different sized chassis 20 should be designed such that they can all interconnect with one another, allowing a user to build a controller 10 having any desired size or shape.

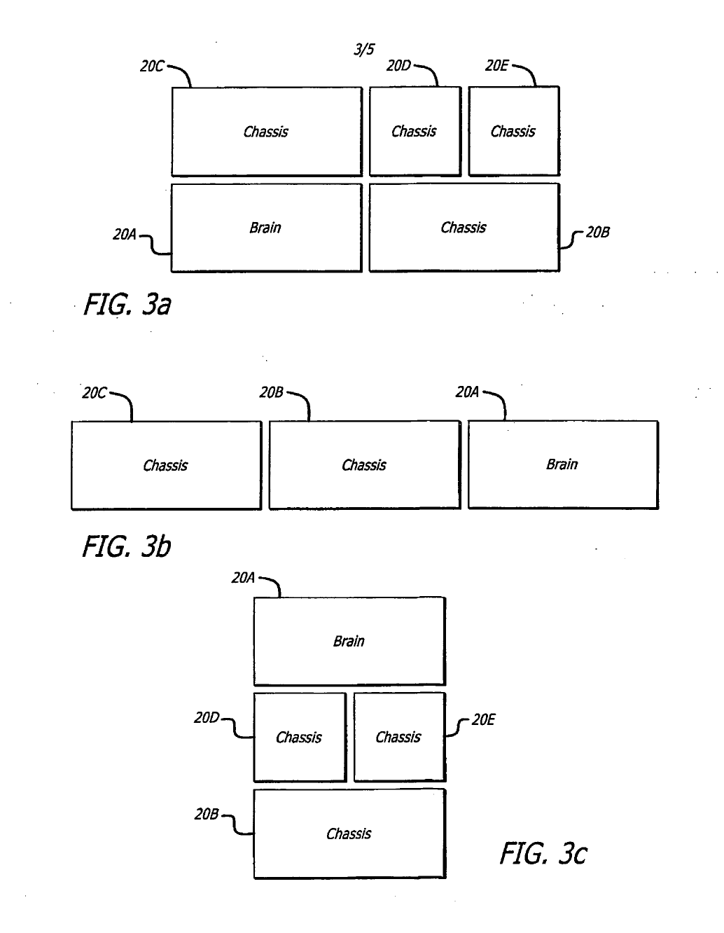

FIGS. 3a-3c are simplified diagrams showing three different illustrative controller configurations for a modular controller 10 designed in accordance with an illustrative embodiment of the present teachings. For these examples, a user has five chassis: a large chassis 20A for holding a system control module or brain 16, two additional large chassis 20B and 20C, and two small chassis 20D and 20E. In the configuration shown in FIG. 3a, a brain chassis 20A has one side connected to chassis 20B and an adjacent side connected to chassis 20C. Chassis 20B has one side connected to the first chassis 20A and an adjacent side connected to the small chassis 20D and 20E. Chassis 20D is connected between chassis 20C and 20E.

In the configuration of FIG. 3b, the three chassis 20A, 20B, and 20C are connected in a row horizontally with chassis 20B connected between chassis 20A and 20C.

In the configuration of FIG. 3c, chassis 20A, 20B, 20D, and 20E are connected to from a vertical column, with the small chassis 20D and 20E connected to form a middle row between chassis 20A and 20B.

Thus, the controller 10 can be reconfigured into different sizes and shapes by attaching multiple chassis 20 as desired. After the multiple chassis 20 are locked in place, they form a single controller 10 that can be easily moved around as one unit. In addition, the types of controls 14.in the controller 10 can be reconfigured by swapping out modules 12 from the slots 22 in the chassis 20. For example, a user may want to use sliders 14D during one part of a recording session and then switch to knobs 14E during another part. As shown in FIG. 1a, the user can simply remove the slider module 12D from its chassis 20 and replace it with a knob module 12E. A user can therefore easily reconfigure the size and shape of the controller 10, as well as the types of controls 14 in the controller 10, as desired for various applications.

Alternatively, the modules 12 may be connected together using a single chassis having multiple slots for holding the modules 12.

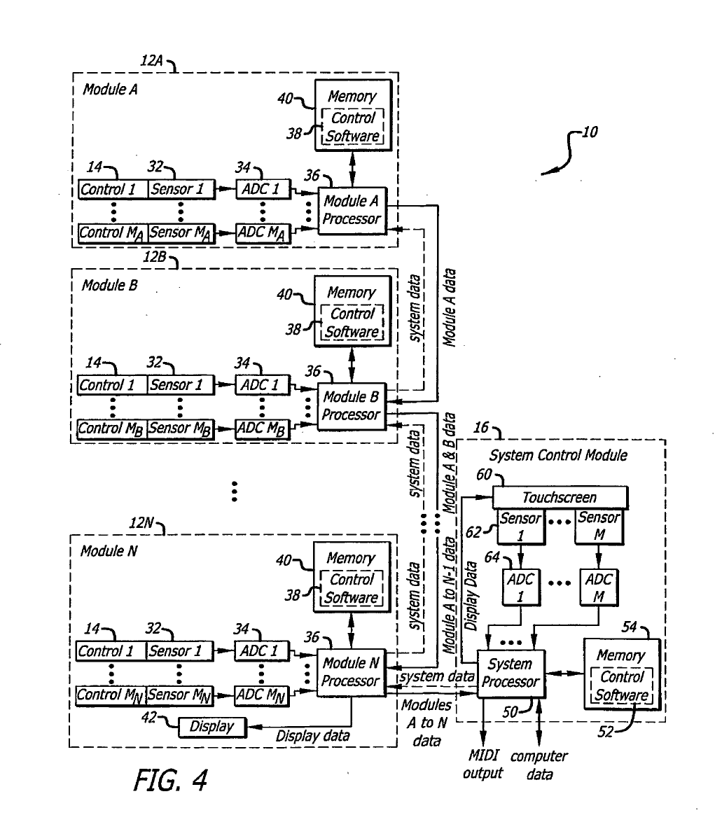

FIG. 4 is a simplified electrical block diagram of a MIDI controller 10 designed in accordance with an illustrative embodiment of the present teachings. As described above, the controller 10 includes a plurality of controller modules 12 (labeled 12A to 12N in FIG. 4) coupled to a system control module 16.

Each controller module 12 includes a plurality of controls 14. Each control 14 includes a sensor or other transducer 32 for converting a mechanical action by the user on the control 14 into a corresponding electrical signal. For example, a key type control may include a simple switch that generates an electrical signal when the key is depressed or a pressure sensor positioned under the key that generates an electrical signal corresponding to how hard the key is depressed, while a slider or knob type control may include a potentiometer that generates an electrical signal corresponding to the position of the slider or knob. Each sensor 32 is coupled to an analog to digital converter (ADC) 34 for digitizing the electrical sensor signals.

Each controller module 12 also includes a processor 36 adapted to receive the digitized sensor signals from each control 14 and generate corresponding control data. The module processor may be implemented using, for example, discrete logic circuits, FPGAs, ASICs, etc., or—as shown in FIG. 4—it may be implemented in software 38 stored in a memory 40 and executed by a microprocessor 36. The module processor 36 may also be adapted to control other module features such as a display 42.

In a preferred embodiment, the processor 36 generates control data that includes digital messages for indicating when a particular control 14 is activated, deactivated, or changed and any associated parameters. For example, the processor 36 may generate a general control message that includes, for example, a module identifier, a control number (or other control identifier), and one or more parameters associated with the control 14, such as “MODULE A, CONTROL 10, INTENSITY=85”. Rather than continuously outputting the values of every control 14, the processor 36 may be adapted to only generate a message when a control value is changed. With controls 14 typically used for controlling musical notes (such as a musical keyboard or drum pads), the processor 36 may generate note on/off messages that convert the control number to a particular pitch, such as “NOTE ON, PITCH=48, INTENSITY=20”. In the simplest embodiment, the processor 36 encodes the controller data using the MIDI data format. In a preferred embodiment, the processor 36 encodes the controller data using a more general data format specific to the modular MIDI controller system that offers more versatility than the MIDI format. The MIDI format is relatively simple and it may be desirable to include additional information in the module output data than can be encoded using MIDI.

By having each module 12 output encoded control data instead of raw sensor signals, the modules 12 can be more easily swapped in and out of the controller 10. New types of controls 14 with more complicated sensors may be implemented in a module 12 without having to modify the system module 16. In the illustrative embodiment of FIG. 4, each control 14 is shown as having one sensor 32. However, a more advanced or complicated control 14 may actually include multiple sensors 32 whose outputs are combined in a particular manner to determine the output value of that control 14. Information on how to interpret the sensor signals is included with the module 12 in the module software 38. The system control module 16 can therefore operate with any modules 12 with any type of controls 14, including new types of controls 14 that are invented after the system control module 16 is built, as long as the module 12 uses the same data format. It is therefore preferable to use a data format that is as general as possible, anticipating any type of control 14 that may be invented.

Even if the module output data is encoded using a standard MIDI data format, the MIDI stream can be transmitted (between modules 12 or to the system control module 16) using a different communications protocol than the conventional MIDI transmission protocol, which is relatively slow (31.25 kbps) and can cause audible delays.

In the illustrative embodiment, the modules 12 are connected in a chain, such that Module A is connected to Module B, Module B is connected to Module C, etc., and the last Module N is connected to the system control module 16. Each module 12 is therefore adapted to receive the control data from the previous module 12 (if applicable), merge the previous control data with its own control data, and output the combined data to the next module 12 or 16. For example, as shown in FIG. 4, Module B receives the control data generated by Module A and outputs data including the data from both Module A and Module B then output from the module 12 and transmitted to the system control module 16. Module N receives the data from Module N-1, which includes the control data from Modules A to N-1, and merges it with the control data from Module N, outputting data from Modules A to N to the system control module 16.

Alternatively, the modules 12 may be connected directly to the system control module 16 (using, for example, external cables or wireless connections such as Bluetooth).

The system control module 16 includes a processor 50 adapted to receive the control data from the modules 12 and generate a single MIDI output. Optionally, the software 52 may also include additional encoding algorithms, allowing the controller 10 to output data in formats other than MIDI. In the illustrative embodiment of FIG. 4, the processor 50 executes software 52 stored in a memory 54. Other implementations may also be used without departing from the scope of the present teachings.

As described above, the system control module 16 may also include a user interface such as a touchscreen 60 having a plurality of pressure sensors 62, each sensor 62 coupled to an analog to digital converter 64. The processor 50 provides a control signal for controlling what is displayed on the touchscreen 60 and also processes the outputs from the ADCs 64.

The processor 50 may also be adapted to receive data from a computer or synthesizer connected to the controller 10 and display the data on the touch screen 60, or send the data to one of the modules 12. In a preferred embodiment, the user interface 60 and processor 50 of the system control module 16 may be used to remotely control a synthesizer or the audio software running on a computer connected to the controller 10. Optionally, the processor 50 may also be adapted to send data to a module 12, such as display data for a module 12 having drum pads labeled by LCD screens as described above.

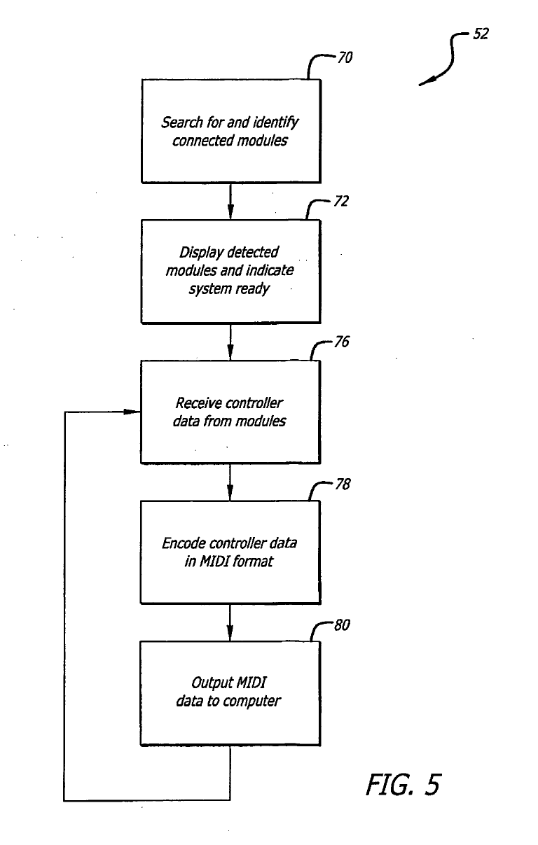

FIG. 5 is a simplified flow diagram for an illustrative processing software 52 for a system control module 16 designed in accordance with an illustrative embodiment of the present teachings. After powering on, at Step 70, the system control module 16 first searches for and identifies any connected control modules 12. The processor 36 of each control module 12 is adapted to send a message to the system control module 16 identifying the module 12 and including information such as the number of controls 14 in the module 12 and the type or types of messages (e.g., note on/off messages or general control messages) the module 12 generates.

After the modules 12 are detected, at Step 72, the system control module 16 indicates to the user that the system is ready for operation. For example, the system processor 50 may list the detected modules 12 on the touchscreen display 60, allowing the user to check module connections if a module 12 is not listed, and then display a message such as “SYSTEM READY”. The processor 50 may also display a menu allowing the user to change system parameters (such as MIDI channel numbers) or communicate (non-MIDI) data with a module 12 or with a synthesizer or computer connected to the controller 10.

During normal operation, the user acts on the various controls 14 of the modules 12, which generates control data. At Step 76, the system control module 16 receives the data from the modules 12 and at Step 78, generates corresponding MIDI data incorporating data received from all connected modules 12. To this end, the processor 50 may designate unique control identifiers for each of the controls 14. For example, Controls 1-5 of Module A may become Controls 1-5 of the overall controller, while Controls 1-8 of Module B may become Controls 6-13 of the overall controller, etc. Optionally, the software 52 may also include additional encoding algorithms, allowing the controller 10 to output data in formats other than MIDI.

Finally, at Step 80, the MIDI data is output to the computer or synthesizer. Steps 76-80 are repeated continuously until the user is finished.

The present invention therefore provides a novel modular MDI controller 10 that can be reconfigured as desired. A variety of different control modules 12 are provided allowing a user to select modules 12 with the type and number of controls 14 required for a particular application. Individual chassis 20 for holding one or more control modules 12 are designed to be fastened together to form one unit, allowing the user to control the size and shape of the controller 10 by connecting the chassis 20 as desired. The chassis 20 have slots 22 for holding the removable modules 12, allowing the user to quickly and easily swap modules 12 when needed. The controller 10 can thus be reconfigured into different sizes and shapes, and with different types and numbers of controls 14, allowing the user to use the same set of modules 12 and chassis 20 for a variety of different applications.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

What is claimed is:

1. A MIDI controller comprising:
at least two modules, each module including a plurality of controls, and
first means for connecting said modules together to form one unit.

2. The invention of claim 1 wherein each control includes means for converting a mechanical action by a user into an electrical signal.

3. The invention of claim 2 wherein each module includes means for converting said electrical signals from said controls into control messages.

4. The invention of claim 3 wherein said control messages include note on/off messages.

5. The invention of claim 3 wherein said controller further includes second means for receiving said control messages from each module and in accordance therewith generating a single encoded output.

6. The invention of claim 5 wherein said encoded output is encoded using a MIDI data format.

7. The invention of claim 6 wherein said second means includes a system control module.

8. The invention of claim 7 wherein said first means includes a plurality of chassis, each chassis adapted to hold one or more of said modules.

9. The invention of claim 8 wherein each chassis includes physical features for attaching said chassis to one or more adjacent chassis.

10. The invention of claim 9 wherein at least one of said chassis includes a slot adapted to hold one or more of said modules.

11. The invention of claim 10 wherein each chassis includes a plurality of electrical connectors for coupling a module in said chassis to a module in an adjacent chassis.

12. The invention of claim 1 wherein said controls include keys, drum pads, buttons, sliders, knobs, wheels, ribbons, trackballs, and/or touch screens.

13. A MIDI controller comprising:
one or more control modules, wherein each control module includes a plurality of controls, each control is adapted to convert a mechanical action by a user into an electrical signal, and each control module includes a processor adapted to convert said electrical signals from said controls into control messages;
a system module adapted to receive said control messages from each control module and in accordance therewith generate a single MIDI output; and
a plurality of chassis connected together to form one unit, each chassis adapted to hold one or more of said modules.

14. A method for reconfiguring a MIDI controller including the steps of:
providing a plurality of modules, each module including a plurality of controls;
providing a plurality of chassis, each chassis adapted to hold one or more of said modules;
connecting a plurality of said chassis together to form a controller having a desired size and shape; and
installing selected modules in said chassis such that said controller includes a desired number and type of controls in a desired configuration.
